(19) United States
(12) Patent Application Publication
(10) Pub. No.: US 2016/0322881 A1
(43) Pub. Date: Nov. 3, 2016

(54) INTEGRATED MOTOR GENERATOR FLYWHEEL WITH ROTATING PERMANENT MAGNET

(71) Applicant: Active Power, Inc., Austin, TX (US)

(72) Inventor: James A. Andrews, Austin, TX (US)

(21) Appl. No.: 15/142,618

(22) Filed: Apr. 29, 2016

Related U.S. Application Data
(60) Provisional application No. 62/154,170, filed on Apr. 29, 2015.

(51) Int. Cl. H02K 7/02; H02K 7/09; H02K 1/02; H02K 1/27; H02K 3/04

(52) U.S. Cl. CPC H02K 7/025; H02K 1/27; H02K 3/04; H02K 1/02; H02K 7/09

(57) ABSTRACT

Provided is a flywheel system, including: an armature coil set; and a rotor assembly having: a first rotor member; a second rotor member; a permanent magnet disposed between the first rotor member and the second rotor member; and a magnetic circuit formed by the first rotor member, the second rotor member, and the permanent magnet, wherein the magnetic circuit spans a gap between the first rotor member and the second rotor member into which at least part of the armature coil set is disposed.

### CROSS-REFERENCE TO RELATED APPLICATIONS

The present patent claims the benefit of U.S. Provisional Patent Applications 62/154,170, filed 29 Apr. 2015, titled “Integrated Motor Generator Flywheel with Rotating Permanent Magnet.” The entire content of each parent application is incorporated by reference in its entirety.

### BACKGROUND

1. Field

The present invention relates generally to flywheel energy storage and, more specifically, to an integrated motor generator flywheel with a rotating permanent magnet.

2. Description of the Related Art

Often flywheels are used to store energy in the form of rotational kinetic energy. In many cases, when power is available, that power is used to accelerate the rotation of a flywheel and later, when power is not available, the resulting stored energy is drawn upon to supply power. Generally, a flywheel's stored kinetic energy is proportional to its mass, the square of its radius, and the square of its rotational speed (RPM). Thus, relatively large, fast flywheels can have relatively high energy density (i.e., energy per unit mass).

In some cases, energy is added to, and withdrawn from, the flywheel via time and space varying electromagnetic fields, for example, with an electric motor and generator integrally formed with the flywheel. In some flywheels, magnetic fields are established with a field coil disposed within the flywheel (e.g., as shown in FIG. 2 of U.S. Pat. No. 6,323,573, titled “High-Efficiency Inductor-Alternator,” filed Mar. 23, 2000, the entire content of which is hereby incorporated by reference in its entirety for all purposes, as the present techniques may be used in conjunction with the surrounding structure). These field coils, in some cases, include a generally toroidal coil of wire through which a current flows to establish a magnetic circuit with which other components interact to add energy to or remove energy from the flywheel. Such field coils are often not rotating and are surrounded by several hundred pounds of rotating mass, for example, forged ferromagnetic material of the flywheel rotors.

In operation, such field coils present certain disadvantages. For example, driver circuitry and mechanical supports add to the complexity of the flywheel energy storage system. And in some cases, such mechanical supports experience relatively high loads as the relatively heavy field coil is supported by cantilevered members extending from outside the flywheel inward. Further, such field coils often generate additional heat that can be difficult to remove from the flywheel due, in part, to the surrounding rotating mass of the flywheel.

### SUMMARY

The following is a non-exhaustive listing of some aspects of the present techniques. These and other aspects are described in the following disclosure.

Some aspects include a flywheel system, including: an armature coil set; and a rotor assembly having: a first rotor member; a second rotor member; a permanent magnet disposed between the first rotor member and the second rotor member; and a magnetic circuit formed by the first rotor member, the second rotor member, and the permanent magnet, wherein the magnetic circuit spans a gap between the first rotor member and the second rotor member into which at least part of the coil set is disposed.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a perspective view of a flywheel assembly in accordance with the present techniques;

FIG. 2 is a cross-sectional perspective view of the flywheel assembly;

FIG. 3 is a sectional perspective view showing the magnetic flux path through the flywheel assembly; and

FIG. 4 is a cross-sectional elevation view of another embodiment of the flywheel assembly in accordance with the present techniques.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of power storage. Indeed, the inventors wish to emphasize the difficulty of recognizing those problems that are nascent and will become much more apparent in the future should trends in the flywheel power supply industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

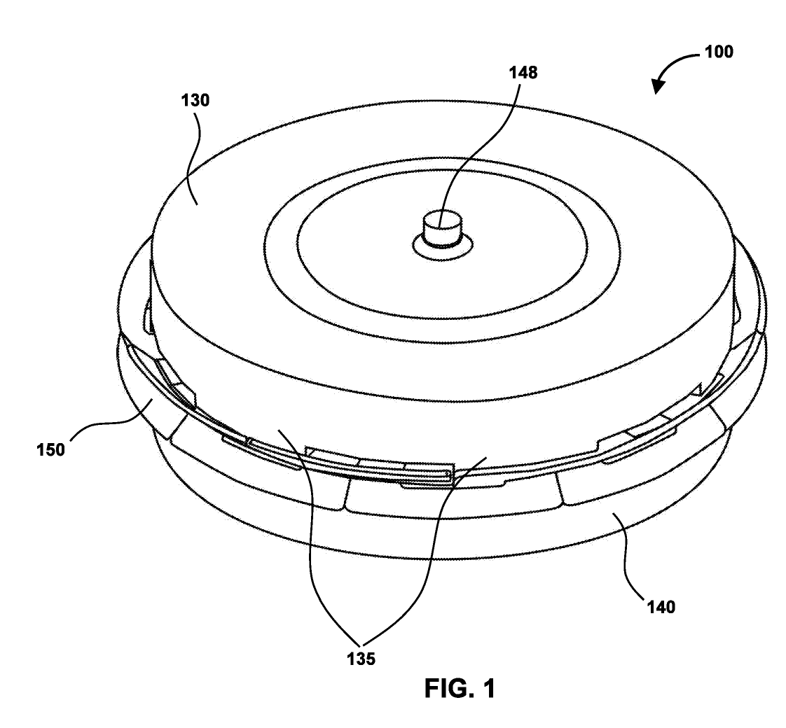

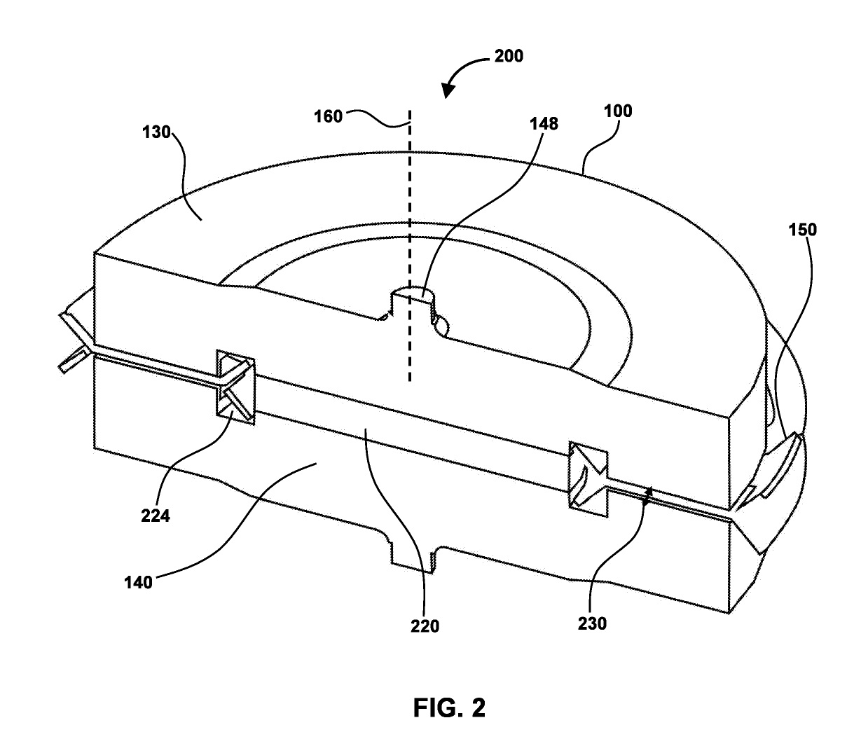

FIGS. 1 and 2 are views of a flywheel assembly that is expected to mitigate some of the above-described issues with traditional systems. In some cases, the illustrative flywheel assemblies may be used in conjunction with the inductor alternators of U.S. Pat. No. 6,118,202, titled “High-Efficiency Inductor Alternator,” filed May 11, 1998, and U.S. Pat. No. 6,323,573, titled “High-Efficiency Inductor-Alternator,” filed Mar. 23, 2000, the entire contents of both of which are hereby incorporated by reference in their entirety for all purposes.

As shown in FIG. 1, flywheel assembly 100 is generally rotationally symmetric about axis of rotation 160 and may include an upper rotor 130, a lower rotor 140, a permanent magnet 220 (shown in FIG. 2), and a three-phase armature coil set 150 therebetween. In some cases, flywheel assembly 100 may include an integrated rotation shaft 165. FIG. 2 is a cross-sectional perspective view 200 of flywheel assembly 100. (The terms “upper” and “lower” are used to distinguish the two components, and should not be read as imposing any particular limitation with respect to gravity.)

Upper and lower rotors 130 and 140 may have a circular cylindrical shape. In some embodiments, upper and lower rotors 130 and 140 may be made from a relatively heavy magnetically conductive material (e.g., iron, nickel, cobalt, manganese, or other magnetically conductive material). In some cases upper and lower rotors 130 and 140 may weight more than 200 pounds. That said, rotors of less or more weight may be used in embodiments consistent with the present techniques.

In some embodiments, upper rotor 130 and lower rotor 140 may include teeth 135 configured to be interdigitated when the flywheel is assembled. In some embodiments, the arc length of the rotor teeth may be substantially equal to (e.g., within 20% of) the arc length of the spaces between each pair of rotor teeth. Matching arc lengths is expected to reduce bucking voltages within the armature coils. In some cases, the teeth may be formed by having teeth on a single rotor (e.g., upper rotor 130), with the other rotor (in these cases lower rotor 140) being a relatively smooth disk. In these cases, the rotor teeth on upper rotor 130 may, for example, be longer than the teeth on both lower rotor 140 and upper rotor 130 when both rotors have teeth. In some cases, teeth 135 of rotors 130 and 140 may be formed by having protrusions on both rotors 130 and 140. In some cases, the teeth and the upper or lower rotor are formed from one piece. For example, the upper (or lower rotor) and teeth may be cast in a mold, or the protrusions defining the teeth may be formed by machining material from the upper (or lower) rotor. In other cases teeth 135 may be connected to the upper or lower rotor (e.g., welded, or via a connector that conducts magnetic flux).

The permanent magnet 220 may be disposed between the upper and lower rotors 130 and 140. In some cases, permanent magnet 220 may generally have a circular cylindrical shape with magnetic poles extending in opposite directions towards the adjacent upper or lower respective rotors, e.g., the south pole of the magnet may be directed toward lower rotor 140 and the north pole towards upper rotor 130 or vice versa. Or other magnet shapes may be used in other embodiments consistent with the present techniques, e.g., octagonal cylinders, hollow cylinders, square cylinders, structures with non-planar bases, etc. Permanent magnet 220 may be radially attached to the upper and lower rotors for example, bolted thereto. In some cases, permanent magnet 220 may be bonded to the upper or lower rotors 130 and 140 via glue or other chemical, mechanical or a non-mechanical, non-chemical connector. Upper and lower rotors 130 and 140, and magnet 220 may define a toroidal volume 224 and an inter-rotor gap 230 in which armature coil set 150 may be disposed. The size of the toroidal volume 224 and inter-rotor gap 230 is defined by the size of magnet 220 and teeth 135. In some embodiments, teeth 135 may include permanent magnets.

In some cases, the upper rotor, the permanent magnet, and the lower rotor may form a single component with zero degrees of relative movement between these components. However, other alternatives are contemplated. For example, in some cases, upper rotor 130 rotates and lower rotor 140 is stationary (or vice versa) with magnet 220 rotating, or upper rotor 130 rotates and lower rotor 140 is stationary (or vice versa) with magnet 220 being stationary.

A variety of different types of permanent magnets may be used. For example, permanent magnet 220 may be a neodymium iron boron magnet. In this case, permanent magnet 220 may have a relatively high coercivity (i.e., resistance to being demagnetized, e.g., in the range of −0.70 to −0.50 percent per degrees Celsius in the range of 20-150 degrees Celsius), and may store large amounts of magnetic energy because of the high saturation magnetization of neodymium iron boron magnets. In some embodiments, a neodymium iron boron magnet may be alloyed with other rare earth metals (e.g., terbium or dysprosium) to form permanent magnet 220 in order to preserve magnetic properties of permanent magnet 220 at high temperatures. Using a neodymium iron boron magnet may be advantageous because of its relative strength, intense field and for its relatively lower cost (because of its intense filed a small magnet may be used).

In some embodiments, other types of rare-earth magnets may be used. For example, in some embodiments, (e.g., where temperature resistance is more important) permanent magnet 220 may be a samarium-cobalt magnet for its relatively high temperature resistance and higher coercivity (generally samarium-cobalt magnet may be heated to a temperature between approximately 700° C. and 800° C. before the magnet loses its magnetism). However, other alternatives to rare earth element magnets also consistent with the present techniques. For example, magnetic metallic elements, composites (e.g., ferrite, or alnico), single molecule magnets, single chain magnets, Nano-structured magnets, rare-earth-free permanent magnets, or other types of permanent magnets.

Armature coil set 150 may include multiple armature coils. In some embodiments, armature coils of armature coil set 150 may generally have a rectangular (or square) shape (other shapes may also be considered). In some embodiments, the end portions of the armature coils are bent such that each coil includes an outer end portion, an inner end portion, and a left and right leg. In some embodiments, the end portions are substantially parallel to one plane, while the legs are substantially parallel to another plane that forms an angle with the end portions plane. In some cases, the end portions plane and the legs plane are slightly offset. In other cases, the end portions plane and the legs plane form an angle that is approximatively less than 90 degrees. When flywheel 100 is assembled, the coils of armature coil set 150 may be layered back to back in two layers (an upper layer and a lower layer) in the inter-rotor gap 230 between the upper and lower rotor (130 and 140) such that an inner end portion of each coil is configured to be disposed in the toroid volume 224 defined by the upper and lower rotors (130 and 140) and permanent magnet 220. In some cases, an outer end portion is configured to be disposed outside of an outer rim of flywheel 100. In some embodiments, the legs of the coils in the upper layer and the legs of the coils in the lower layer are substantially parallel to the same plane. In some implementations, coils in the upper layer face upper rotor 130 and have legs that are bent toward lower rotor 140, while coils in the lower layer face lower rotor 140 and have legs that are bent toward upper rotor 130.

In some embodiments, armature coil set 150 may be a three phase armature coil set. In these cases (and other cases where armature coil sets are poly-phase), the armature coils may be displaced circumferentially about the centerline, some of which are in parallel in a given phase. For example, armature coil set 150 may include twenty-four armature coils (formed in two layers of twelve coils each, eight coils per phase, and with three electrical phases). In some cases, the twenty-four armature coils may be circumferentially spaced (and nested) every fifteen mechanical degrees. Or other amounts of coils may be used in some embodiments. For example, other three-phase armatures with more or less armature coils (the armature coils being divisible by three to maintain proper phase alignment), or other single or poly-phase armatures may be used consistent with the present techniques.

In some embodiments, coils of armature coil set 150 may include solid pieces of an electrically conductive, low permeability material (e.g., copper). In some cases, the coils may include turns of wire. Coils of armature coil set 150 may be wound with enameled copper wire, termed magnet wire, or winding material having a low resistance (to reduce the power consumed by the field coil, and to reduce the waste heat produced by ohmic heating). In some cases, aluminum windings may be used for their relatively low cost. In some embodiments, the turns of wires may consist of a plurality of electrical conductors that are electrically insulated from each other and are electrically connected together in parallel. For example, in some cases, a litz wire constructed of individual film-insulated wires bunched or braided together in a uniform pattern of twists and length of lay may be used. In these cases, a coil formed of litz wire has at least one set of conductors that are parallel to each other coupled together in series with at least one other set of parallel conductors. This configuration may reduce skin effect power losses of solid conductors, or the tendency of high frequency current to be concentrated at the conductor surface. Generally, litz wires have individual strands each positioned in a uniform pattern moving from the center to the outside and back within a given length of the wire. In addition to the reduction of skin effect losses, litz wire and other multi-strand bundles of small gauge wire may produce lower eddy current losses than a single strand of larger wire.

In operation, the upper rotor 130, the permanent magnet 220, and the lower rotor 140 may rotate together about the axis of symmetry 160, while the armature coil set 150 may remain generally static, experiencing time varying magnetic flux as the teeth of the rotors rotate past, varying the gap through the magnetic circuit spans. Flywheel 100 may store rotational kinetic energy. In some embodiments, the amount of energy stored in flywheel 100 is proportional to the square of the flywheel's rotational speed. In some cases, the flywheel may have revolution rate of a thousand revolution per minute (RPM) or greater. Energy may be transferred to flywheel 100 by the application of a torque to it by driving a time-varying current through the coils, thereby increasing its rotational speed, and its stored energy. Conversely, flywheel 100 may release stored energy by inducing a time-varying current in the coils and driving a load with the resulting electrical power. In some embodiments, flywheel 100 may behave as a unitary rotor formed from a single piece of material. In some cases, flywheel 100 includes an integral shaft 148 configured to facilitate rotation of flywheel 100 about axis 160. The use of an integral shaft for rotation of flywheel 100 may provide an advantage of not limiting the tip speed of the rotor. The resulting time varying magnetic flux passing through the armature coils may drive a current that may be used as a power source in times in which power is absent, and when power is present, appropriately timed and directed current driven through the armature coils may be used to add energy to the rotors.

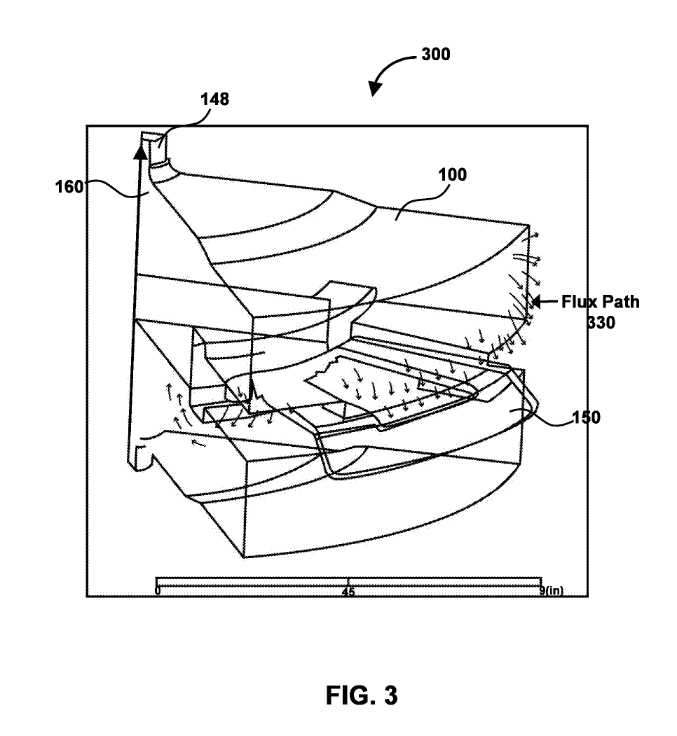

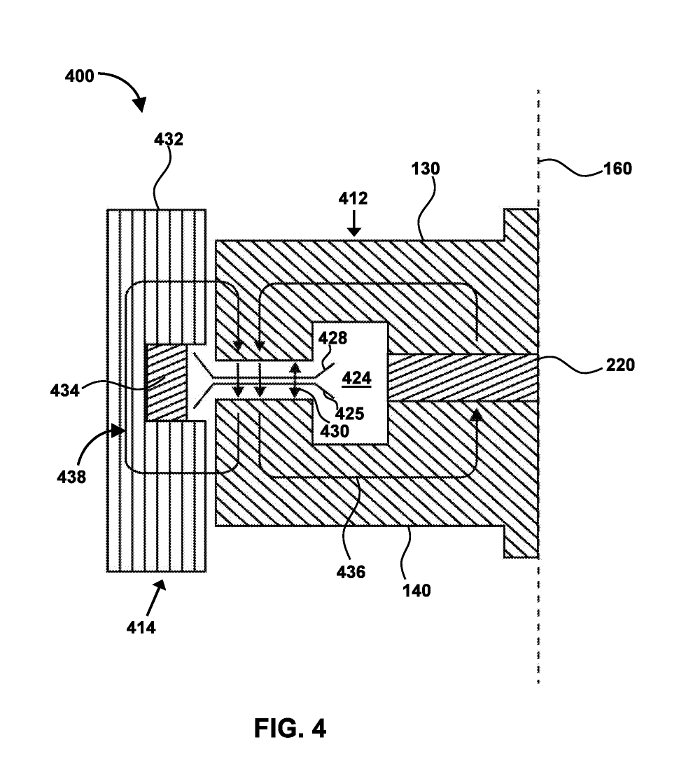

As shown in the flux diagram of FIG. 3 (and more clearly in the magnetic circuit 436 of FIG. 4), the permanent magnet 220 may establish a magnetic circuit with magnetic flux 330 passing through the armature coils (FIG. 3 shows a sectional perspective view 300 showing the magnetic flux path 300 through a flywheel assembly 100 having a single armature coil 150), without the need for a relatively heavy, relatively complicated, and relatively thermally undesirable field coil being positioned between the upper rotor and the lower rotor. This is expected to reduce the cost of the rotor assembly, facilitate use of the rotor assembly in more thermally demanding applications, and improve reliability of the rotor assembly by removing complexity and, in particular, relatively high stress support structures for the field coil. That said, embodiments are consistent with use of a field coil. For instance, the present techniques may be used to reduce the size and load from a field coil by supplementing the field coil's magnetic flux with that of the permanent magnets. In some cases, if magnet 220 demagnetizes (e.g., in case the rotor heats excessively) a slip ring may transfer energy to the rotor assembly. For example, some embodiments may use a pancake slip ring having conductors arranged on a flat disc as concentric rings centered on the rotor assembly rotating shaft 148.

In some embodiments, flywheel assembly 100 may be used for purposes other than storing power, e.g., controlling the orientation of a mechanical system attached to the flywheel (e.g., transferring the angular momentum of the flywheel to the mechanical system when energy is transferred to or from the flywheel and causing the attaching system to rotate into some desired position). For example, flywheel 100 may be used to control satellite orientation. In these cases, two counter-rotating flywheels 100 may be used to orient a satellite's instruments without the use of thruster rockets.

In some embodiments, flywheel 100 may provide continuous (e.g., over some duration of time, like more than ten seconds, or more than 30 seconds) energy in systems where the energy source is not continuous (e.g., after a failure of grid power). In such cases, the flywheel stores energy when a time varying current is driven by the grid, and flywheel releases the stored energy when the movement of the flywheel induces a current connected to a load.

In some embodiments, flywheel 100 may supply intermittent pulses of energy at transfer rates that exceed the abilities of its energy source, or when such pulses would disrupt the energy supply (e.g., public electric network). This may be achieved by accumulating stored energy in the flywheel over a period of time, at a rate that is compatible with the energy source, and then releasing that energy at a much higher rate over a relatively short time when it is needed (e.g., flywheel 100 may be used in riveting machines to store energy from the motor and release it during the riveting operation).

FIG. 4 is a cross-section showing another example of a flywheel system 400 having a rotor assembly 412 like that described above with reference to FIGS. 1 through 3 and an adjustable flux excitation ring 414 positioned concentrically around the rotor assembly 412. The rotor assembly 412 and the excitation ring 414 may be generally rotationally symmetric about axis of rotation 160. (For simplicity, only one half of the flywheel system 400 is shown in a half-rotor sectional view.) As noted above, the rotor assembly 412 may include an upper rotor 130 and a lower rotor 140 both in contact with a permanent magnet 220.

As described above an upper rotor 130, lower rotor 140 and magnet 220 may define a toroidal volume 424 and an inter-rotor gap 430 in which upper and lower armature coils 426 and 428 may be disposed. The rotor assembly 412 may be mounted to bearings (e.g., magnetic, non-contact bearings), such that the rotor assembly 412 may rotate while the flux excitation ring 414 and armature coils 426 and 428 remain generally static. For example, the outer portion of the integral shaft may be mounted to the bearings.

The flux excitation ring 414 may be disposed adjacent and concentrically around outer rim of the rotor assembly 412. The flux excitation ring 414 may include a ring core 432 made of a magnetically conductive material and a field coil 434 operative to establish a magnetic flux when a current is driven through the coil 434. For example, flux excitation ring 414 may establish a homopolar magnetic flux within rotor assembly 112 when energized (e.g., by a DC current).

In some cases, field coil 434 may be a coil of wire through which a current flows. Coils of field coil 434 may be wound with enameled copper wire, termed magnet wire, or winding material having a low resistance (to reduce the power consumed by the field coil, and to reduce the waste heat produced by ohmic heating). In some cases, aluminum windings may be used for their relatively low cost. In other cases, silver may be used for its lower resistivity.

In operation, magnetic field lines or magnetic circuit 438 pass in a continuous loop from the excitation ring 414 through the rotor assembly 412 and back through the excitation ring 414 again. Permanent magnet 220 may establish a magnetic flux circuit 436 through the upper and lower rotors (130 and 140) and armature coils 426 and 428. Flux excitation ring 414 may establish a magnetic circuit 438 that also passes through the upper and lower rotors 130 and 140 and the armature coils 426 and 428. The flux density of circuit 438 may be adjusted by adjusting current through coil 434 to adjust for changes in rotational speed of rotor assembly 412.

In some embodiments, when drawing power from the flywheel, as the rotor assembly 412 slows down, the current through the coil 434 may be ramped up to increase the magnetic flux from the circuit 438 and to thereby reduce the amount of decrease in power produced by the flywheel 412 that would otherwise occur as the rotational speed of the rotor assembly 412 drops.

In some cases, the current through the coil 434 may be adjusted in accordance with the rotational speed of the rotor assembly 412, such that the power produced by the flywheel assembly 400 remains generally constant, e.g., in accordance with a feedback control loop implemented with a lookup table of output currents and sensed input rotor speeds.

In some embodiments, flywheel assembly 100 may be used with an uninterruptible power supply (UPS), where the UPS is powered by the flywheel energy. When utility power fails, the stored energy in flywheel assembly 100 may be converted to a high frequency (alternative current) AC output voltage from armature coils 150. A converter may convert high frequency AC power (e.g., from 300 to about 2,000 Hz or higher) into 50 or 60 Hz power that can be routed to a load. In this case, the UPS provides secondary power for intermittent losses of utility power without chemical batteries, as are traditionally used. Additionally, the UPS may provide secondary power in the event of a total loss of utility power for enough time so that either an orderly shutdown of critical equipment may occur, or until a backup standby generator may be brought on-line. Alternatively, the UPS can be used as a DC energy storage system, in which case it would be connected to the DC buss of a conventional UPS (not shown). Generally, uninterruptible power supply (UPS) devices are ready for immediate use at the instant that the power fails. They generally store small amount of energy which makes them suitable for a few seconds or minutes of use.

In some embodiments, the flywheel assembly 100 may be used in diesel rotary uninterruptible power supply devices (DRUPS) which combine the functionality of a flywheel-powered UPS and a diesel generator. In theses cases, an electrical generator with a mass functions as motor to store kinetic energy in flywheel assembly 100. In combination with a reactor, the electrical generator may also work as an active filter (e.g., frequency variations, harmonics, etc.) If the power fails, energy stored in the flywheel is released to drive the electrical generator, and the diesel engine takes over from the flywheel to drive the electrical generator to provide electricity. The flywheel may support the diesel generator in order to keep a stable output frequency. Typically a DRUPS will have enough fuel to power the load for days or even weeks in the event of failure of the mains electricity supply. Use of a DRUPS having flywheel 100 may be advantageous compared to battery-powered UPS combined with a diesel-generator because of a higher overall system energy efficiency, smaller footprint, use of fewer components, longer technical lifetime, and lower chemical waste.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, any such conflicting text in such incorporated by reference U.S. patents, U.S. patent applications, and other materials is specifically not incorporated by reference in this patent.

The present techniques will be better understood with reference to the following enumerated embodiments:

1. A flywheel system comprising: an armature coil set; and a rotor assembly comprising: a first rotor member; a second rotor member; a permanent magnet disposed between the first rotor member and the second rotor member; and a magnetic circuit formed by the first rotor member, the second rotor member, and the permanent magnet, wherein the magnetic circuit spans a gap between the first rotor member and the second rotor member into which at least part of the armature coil set is disposed.
2. The flywheel system of embodiment 1, comprising: a flux excitation ring disposed circumferentially around the first rotor assembly and the second rotor assembly, the flux excitation ring having a coil and circuitry operative to adjust current through the coil based on a speed of rotation of the rotor assembly.
3. The flywheel system of embodiment 2, wherein magnetic field lines from the excitation ring pass in a continuous loop from the excitation ring through the first rotor member, the second rotor member and the armature coil set and back through the excitation ring.
4. The flywheel system of claim 1, wherein the armature coil set is a three-phase armature coil set.
5. The flywheel system of any of embodiments 1-4, comprising: an integrated rotation shaft configured to facilitate rotation of the flywheel system about an axis; and magnetic bearings positioned to confine movement of the rotor assembly other than rotation about the axis.
6. The flywheel system of any of embodiments 1-5, wherein the armature coil set mounted in fixed relation relative to a housing in which the rotor assembly is disposed, and wherein the armature coil set is configured to rotate relative to the armature coil set.
7. The flywheel system of any of embodiments 1-6, wherein the first rotor member or the second rotor member includes multiple protrusions extending therefrom toward the other rotor member in angular spaced relation, and wherein the armature coil set is disposed between the protrusions and the other rotor member.
8. The flywheel system of embodiment 6, wherein both the first rotor member and the second rotor member include a plurality of interdigitated teeth extending toward the opposing rotor member.
9. The flywheel system of any of embodiments 1-8, wherein the magnetic circuit from the permanent magnet passes in a loop through the first rotor member, the second rotor member, and the armature coil set.
10. The flywheel system of any of embodiments 1-9, wherein the permanent magnet is a rare-earth magnet.
11. The flywheel system of any of embodiments 1-10, comprising: a load electrically coupleable to the armature coil set; and an internal-combustion engine generator electrically coupleable to the load.
12. The flywheel system of any of embodiments 1-11, comprising: a feedback control loop configured to adjust current through the armature coil set based on a rotation velocity of the rotor assembly.
13. A method comprising: rotating a flywheel, the flywheel comprising a an armature coil set, a first rotor member, a second rotor member, and a permanent magnet disposed between the first rotor member and the second rotor member; and conducting magnetic flux through a magnetic circuit comprising the first rotor member, the second rotor member, and the permanent magnet, wherein the magnetic circuit spans a gap between the first rotor member and the second rotor member into which at least part of the armature coil set is disposed.
14. The method of embodiment 13, comprising: augmenting magnetic flux in a portion of the magnetic circuit with an excitation ring, the excitation ring being disposed circumferentially around the first rotor member and the second rotor member, wherein at least part of the magnetic circuit is not augmented.
15. The method of any of embodiments 13-14, comprising: adjusting current through the excitation ring in response to a measured or inferred amount of electrical power generated by the flywheel.
16. The method of any of embodiments 13-15, comprising: outputting electrical power from the armature coil set; and converting a frequency of the electrical power.
17. The method of any of embodiments 13-16, comprising: applying a force orthogonal to an axis of rotation of the flywheel with a magnetic rotational bearing; and applying a force parallel to the axis of rotation of the flywheel with a magnetic thrust bearing.
18. The method of any of embodiments 13-17, varying an intensity of the magnetic flux over time in a given portion of the armature coil set
19. The method of any of embodiments 13-18, varying a gap between the first rotor member and the second rotor member into which at least part of the portion of the armature coil set is disposed.
20. The method of any of embodiments 13-19, comprising: storing electrical energy by driving rotation of the flywheel assembly with grid electrical power; drawing electrical energy from the flywheel assembly by inducing a current through armature coil set with rotation of the flywheel assembly; and powering a load with the drawn electrical energy.

What is claimed is:

1. A flywheel system comprising:
an armature coil set; and
a rotor assembly comprising:
a first rotor member;
a second rotor member;
a permanent magnet disposed between the first rotor member and the second rotor member; and
a magnetic circuit formed by the first rotor member, the second rotor member, and the permanent magnet, wherein the magnetic circuit spans a gap between the first rotor member and the second rotor member into which at least part of the armature coil set is disposed.

2. The flywheel system of claim 1, comprising:
a flux excitation ring disposed circumferentially around the first rotor assembly and the second rotor assembly, the flux excitation ring having a coil and circuitry operative to adjust current through the coil based on a speed of rotation of the rotor assembly.

3. The flywheel system of claim 2, wherein magnetic field lines from the excitation ring pass in a continuous loop from the excitation ring through the first rotor member, the second rotor member and the armature coil set and back through the excitation ring.

4. The flywheel system of claim 1, wherein the armature coil set is a three-phase armature coil set.

5. The flywheel system of claim 1, comprising:
an integrated rotation shaft configured to facilitate rotation of the flywheel system about an axis; and
magnetic bearings positioned to confine movement of the rotor assembly other than rotation about the axis.

6. The flywheel system of claim 1, wherein the armature coil set mounted in fixed relation relative to a housing in which the rotor assembly is disposed, and wherein the armature coil set is configured to rotate relative to the armature coil set.

7. The flywheel system of claim 1, wherein the first rotor member or the second rotor member includes multiple protrusions extending therefrom toward the other rotor member in angular spaced relation, and wherein the armature coil set is disposed between the protrusions and the other rotor member.

8. The flywheel system of claim 6, wherein both the first rotor member and the second rotor member include a plurality of interdigitated teeth extending toward the opposing rotor member.

9. The flywheel system of claim 1, wherein the magnetic circuit from the permanent magnet passes in a loop through the first rotor member, the second rotor member, and the armature coil set.

10. The flywheel system of claim 1, wherein the permanent magnet is a rare-earth magnet.

11. The flywheel system of claim 1, comprising:
a load electrically coupleable to the armature coil set; and
an internal-combustion engine generator electrically coupleable to the load.

12. The flywheel system of claim 1, comprising:
a feedback control loop configured to adjust current through the armature coil set based on a rotation velocity of the rotor assembly.

13. A method comprising:
rotating a flywheel, the flywheel comprising an armature coil set, a first rotor member, a second rotor member, and a permanent magnet disposed between the first rotor member and the second rotor member; and
conducting magnetic flux through a magnetic circuit comprising the first rotor member, the second rotor member, and the permanent magnet, wherein the magnetic circuit spans a gap between the first rotor member and the second rotor member into which at least part of the armature coil set is disposed.

14. The method of claim 13, comprising:
augmenting magnetic flux in a portion of the magnetic circuit with an excitation ring, the excitation ring being disposed circumferentially around the first rotor member and the second rotor member, wherein at least part of the magnetic circuit is not augmented.

15. The method of claim 14, comprising:
adjusting current through the excitation ring in response to a measured or inferred amount of electrical power generated by the flywheel.

16. The method of claim 13, comprising:
outputting electrical power from the armature coil set; and
converting a frequency of the electrical power.

17. The method of claim 13, comprising:
applying a force orthogonal to an axis of rotation of the flywheel with a magnetic rotational bearing; and
applying a force parallel to the axis of rotation of the flywheel with a magnetic thrust bearing.

18. The method of claim 13, varying an intensity of the magnetic flux over time in a given portion of the armature coil set.

19. The method of claim 13, varying a gap between the first rotor member and the second rotor member into which at least part of the portion of the armature coil set is disposed.

20. The method of claim 13, comprising:
storing electrical energy by driving rotation of the flywheel assembly with grid electrical power;
drawing electrical energy from the flywheel assembly by inducing a current through armature coil set with rotation of the flywheel assembly; and
powering a load with the drawn electrical energy.
